(19) United States
(12) Patent Application Publication
(10) Pub. No.: US 2024/0248739 A1
(43) Pub. Date: Jul. 25, 2024

(54) AUTOMATE SUSPENSION AND REDEPLOYMENT OF CLOUD RESOURCES

(71) Applicant: VMWARE LLC, Palo Alto, CA (US)

(72) Inventors: JERRY IBRAHIM, Palo Alto, CA (US); SREEKANTHA REDDY INDIREDDY, Bangalore (IN); ABHINAV SINGH, Chandigarh (IN); SWAPNIL SUDHIR HENDRE, Erie, CO (US); MUKUND YADAV, Cupertino, CA (US)

(21) Appl. No.: 18/139,987

(22) Filed: Apr. 27, 2023

(30) Foreign Application Priority Data
Jan. 25, 2023 (IN) 202341005191

(51) Int. Cl. G06F 9/455; G06F 9/50

(52) U.S. Cl. CPC G06F 9/45558; G06F 9/5077; G06F 2009/45595

(57) ABSTRACT

Methods, apparatus, systems, and articles of manufacture are disclosed to automate suspension and redeployment of cloud resources. The example apparatus is to, based on network traffic associated with a compute cluster hosting a containerized application, determine whether to suspend the containerized application. Additionally, the example apparatus is to determine a port of a transient container that is available to be mapped to the containerized application and cause a request to access the containerized application to be forwarded to the port of the transient container instead of the containerized application. The example apparatus is also to deprovision one or more resources associated with the containerized application.

### RELATED APPLICATIONS

Benefit is claimed under 35 U.S.C. 119(a)-(d) to Foreign Application Serial No. 202341005191 filed in India entitled “METHODS, APPARATUS, AND ARTICLES OF MANUFACTURE TO AUTOMATE SUSPENSION AND REDEPLOYMENT OF CLOUD RESOURCES”, on Jan. 25, 2023, by VMware, Inc., which is herein incorporated in its entirety by reference for all purposes.

### FIELD OF THE DISCLOSURE

This disclosure relates generally to virtualized computing and, more particularly, to methods, apparatus, and articles of manufacture to automate suspension and redeployment of cloud resources.

### BACKGROUND

Virtualizing computer systems provides benefits such as the ability to execute multiple computer systems on a single hardware computer, replicating computer systems, moving computer systems among multiple hardware computers, and so forth. “Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform (sometimes referred to as a “private cloud”) that gives an application developer access to infrastructure resources, such as virtualized servers, storage, and networking resources. By providing ready access to the hardware resources required to run an application, the cloud computing platform enables developers to build, deploy, and manage the lifecycle of a web application (or any other type of networked application) at a greater scale and at a faster pace than ever before.

### BRIEF DESCRIPTION OF THE DRAWINGS

FIG. 1 illustrates an example virtual environment including an example client device accessing at least one of a first example compute cluster or a second example compute cluster via an example network layer.

FIG. 2 is a block diagram illustrating example automated suspension circuitry in relation to the virtual environment of FIG. 1.

FIGS. 3-6 illustrate example operations of the automated suspension circuitry of FIG. 2.

FIG. 7 is a flowchart representative of example machine readable instructions and/or example operations that may be executed by example processor circuitry to implement the automated suspension circuitry of FIG. 2 to suspend a containerized application.

FIG. 8 is a flowchart representative of example machine readable instructions and/or example operations that may be executed by example processor circuitry to implement the automated suspension circuitry of FIG. 2 to redeploy a containerized application.

FIG. 9 is a block diagram of an example processing platform including processor circuitry structured to execute the example machine readable instructions and/or the example operations of FIGS. 7 and/or 8 to implement the automated suspension circuitry of FIG. 2.

FIG. 10 is a block diagram of an example implementation of the processor circuitry of FIG. 9.

FIG. 11 is a block diagram of another example implementation of the processor circuitry of FIG. 9.

FIG. 12 is a block diagram of an example software distribution platform (e.g., one or more servers) to distribute software (e.g., software corresponding to the example machine readable instructions of FIGS. 7 and/or 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform (e.g., the instructions cause) specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s). In some examples, an ASIC is referred to as Application Specific Integrated Circuitry.

### DETAILED DESCRIPTION

Cloud computing is based on the deployment of many physical resources across a network, virtualizing the physical resources into virtual resources, and provisioning the virtual resources in software defined data centers (SDDCs) for use across cloud computing services and applications. SDDCs may be implemented on-premises or off-premises. For example, an on-premises SDDC is implemented on the premises of an enterprise. That is, the hardware resources that execute and/or otherwise implement the SDDC are situated on the premises of the enterprise. Additionally or alternatively, an off-premises SDDC is implemented off the premises of an enterprise. That is, the hardware resources that execute and/or otherwise implement the SDDC are situated off the premises of the enterprise.

Examples disclosed herein can be used to improve performance and efficiencies of network communications between different virtual and/or physical resources of SDDCs. Examples disclosed herein may be used in connection with different types of SDDCs. In some examples, techniques disclosed herein are useful for managing network resources that are provided in SDDCs based on Hyper-Converged Infrastructure (HCl). In some examples, HCl combines a virtualization platform such as a hypervisor, virtualized software-defined storage, and virtualized networking in an SDDC deployment. An SDDC manager can provide automation of workflows for lifecycle management and operations of a self-contained private cloud instance. Such an instance may span multiple racks of servers connected via a leaf-spine network topology and connects to the rest of the enterprise network for north-south connectivity via well-defined points of attachment.

Examples disclosed herein can be used with an example virtualization environment, such as operating system (OS) virtualization. OS virtualization is also referred to herein as container virtualization. As used herein, OS virtualization refers to a system in which processes are isolated in an OS. In a typical OS virtualization system, a host OS is installed on the server hardware. Alternatively, the host OS can be installed in a virtual machine (VM) of a full virtualization environment or a paravirtualization environment. The host OS of an OS virtualization system is configured (e.g., utilizing a customized kernel, etc.) to provide isolation and resource management for processes that execute within the host OS (e.g., applications that execute on the host OS, etc.). The isolation of the processes is known as a container.

Thus, a process executes within a container that isolates the process from other processes executing on the host OS. Thus, OS virtualization provides isolation and resource management capabilities without the resource overhead utilized by a full virtualization environment or a paravirtualization environment. Example OS virtualization environments include Linux Containers LXC and LXD, the DOCKER™ container platform, the OPENVZ™ container platform, etc. Example container orchestration managers include a Kubernetes® K8S™ software that coordinate and schedule the deployment and execution of containers associated with a distributed application (e.g., a containerized application). As used herein, the term “containerized application” refers to one or more isolated applications or services executing on a single host that have access to the same OS kernel. As used herein, the term “application containerization” refers to an OS-level virtualization method used to deploy and run distributed applications without launching an entire VM for each one of the distributed applications. A containerized application may include one or more containers, also known as micro-services, that perform specific tasks and/or services, such that the containerized application is a collection of containers in communication with one another.

In some examples, an OS virtualization system may be managed and/or utilized by multiple developers and teams across multiple locations. For example, containerized applications and/or a containerized infrastructure may be developed, monitored, managed, updated, deployed, etc., by different developers. As such, containerized applications and/or containerized infrastructure may be implemented for a variety of environment and/or for a variety of purposes.

However, as enterprises move from on-premises data centers to off-premises data centers, the enterprises tend not to update containerized applications and/or a containerized infrastructure in view of the updated cloud infrastructure. For example, containerized applications and/or services that were originally developed for deployment in on-premises SDDCs (e.g., where computational resources are relatively more reliable, flexible, and secure than off-premises SDDCs) are not updated to be turned off (e.g., deprovisioned). As such, some computational resources on which the containerized applications and/or services are deployed remain provisioned despite the fact that the containerized applications and/or services are unused for long periods of time. Thus, enterprises implementing containerized applications and/or containerized infrastructure may incur increased costs as the containerized applications and/or the containerized infrastructure remain active despite not actively being used by the enterprises.

To address provisioned, yet unused, containerized applications and/or containerized infrastructure, some cloud service providers (CSPs) have implemented automated shutdown procedures to deprovision inactive containerized applications and/or containerized infrastructure. However, when an end-user associated with an enterprise seeks to access a containerized application and/or containerized infrastructure that has been shut down, the end-user will receive an error message because the containerized application and/or containerized infrastructure is not provisioned and therefore unavailable. In such situations, a developer associated with the enterprise must manually reprovision the containerized application and/or containerized infrastructure before the end-user can access the containerized application and/or containerized infrastructure.

Examples disclosed herein includes methods, apparatus, and articles of manufacture to automate suspension and redeployment of cloud resources. As such, in examples disclosed herein, when a containerized application is inactive, disclosed methods, apparatus, and articles of manufacture suspend the containerized application, monitor requests for the containerized application, and in response to receipt of a request for the containerized application, restart (e.g., reprovision) the containerized application) without human intervention.

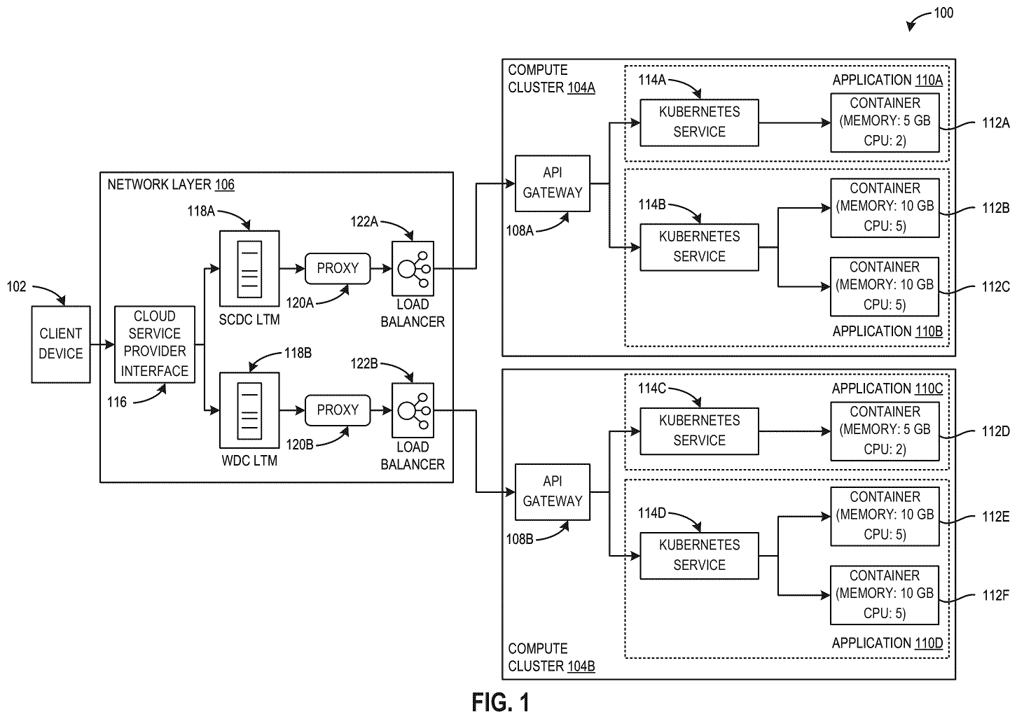

FIG. 1 illustrates an example virtual environment 100 including an example client device 102 accessing at least one of a first example compute cluster 104A or a second example compute cluster 104B via an example network layer 106. The virtual environment 100 of FIG. 1 corresponds to a virtual or software-based abstraction of a physical environment. The physical environment may include a physical rack that includes a host. Alternatively, the physical environment may include a plurality of physical racks with a plurality of hosts. The host is a physical server including hardware-level components that may include one or more central processor units (CPUs), one or more memory devices, one or more storage units, one or more graphics processor units (GPUs), etc.

In the illustrated example of FIG. 1, the first compute cluster 104A is implemented by two or more hosts connected via a local area network (LAN). Operations performed by the first compute cluster 104A are orchestrated by software (e.g., clustering middleware) executing on the two or more hosts of the first compute cluster 104A. The two or more hosts that implement the first computer cluster 104A may be referred to as nodes. The orchestration software allows for end-users to treat the nodes (e.g., hosts computers) of the first compute cluster 104A as a single computer.

For example, the first compute cluster 104A includes a first example application programming interface (API) gateway 108A. In the example of FIG. 1, the first API gateway 108A is implemented by at least one hypervisor and at least one load balancer. For example, the hosts of the first compute cluster 104A execute the first API gateway 108A (e.g., a hypervisor), which provides local virtualization services to create one or more containers on the first compute cluster 104A. The hypervisor may be implemented using any suitable hypervisor (e.g., VMWARE® ESXI® hypervisor, Microsoft HYPER-V® hypervisor, and Kernel Based Virtual Machine (KVM)).

In some examples, the first API gateway 108A (e.g., the hypervisor) instantiates one or more containers. For example, the first API gateway 108A (e.g., the hypervisor) instantiates containers to execute a first example application 110A and a second example application 110B. In the example of FIG. 1, the first application 110A and the second application 110B are containerized applications. For example, the first API gateway 108A (e.g., the hypervisor) may deploy one or more pods on the first compute cluster 104A which may include one or more of the containers to execute instances of distributed applications or services to facilitate execution of the first application 110A and/or the second application 110B.

In the illustrated example of FIG. 1, a pod groups two or more containers. As used herein, a pod refers to a group of one or more containers that include shared network and storage. A pod is a logical construct that couples containers together. In some examples, a pod is a smallest divisible unit in a container orchestration manager (e.g., the Kubernetes® software). In such examples, all containers in a pod remain together on the resource in which that pod is scheduled. In the example of FIG. 1, the first API gateway 108A (e.g., a load balancer) directs network traffic associated with the first application 110A and the second application 110B to the corresponding application (e.g., to the pod executing the corresponding application). In some examples, the first API gateway 108A (e.g., the load balancer) adjusts the number of containers associated with a containerized application as demand dictates. For example, the first API gateway 108A deploys one or more additional containers to a pod executing the first application 110A in response to (e.g., based on) an increased demand (e.g., a larger number of requests) for the first application 110A.

As described above, the first API gateway 108A instantiates containers to execute the first application 110A and the second application 110B. For example, to implement the first application 110A, the first API gateway 108A instantiates a first example container 112A to execute a first example service 114A. Additionally, for example, to implement the second application 1101B, the first API gateway 108A instantiates a second example container 112B and a third example container 112C to execute a second example service 114B.

In the illustrated example of FIG. 1, the second compute cluster 104B is implemented by two or more hosts connected via a LAN. Operations performed by the second compute cluster 104B are orchestrated by software (e.g., clustering middleware) executing on the two or more hosts of the second compute cluster 104B. The orchestration software allows for end-users to treat the nodes (e.g., hosts computers) of the second compute cluster 104B as a single computer.

For example, the second compute cluster 104B includes a second example API gateway 108B. The example second API gateway 108B is implemented similarly to the first API gateway 108A. For example, the second API gateway 108B of the illustrated example instantiates containers to execute a third example application 110C and a fourth example application 110D. In the example of FIG. 1, the third application 110C and the fourth application 110D are containerized applications.

In the illustrated example of FIG. 1, to implement the third application 110C, the second API gateway 108B instantiates a fourth example container 112D to execute a third example service 114C. Additionally, for example, to implement the fourth application 110D, the second API gateway 108B instantiates a fifth example container 112E and a sixth example container 112F to execute a fourth example service 114D. As described above, the example second API gateway 108B is implemented similarly to the first API gateway 108A. For purposes of conciseness, the second API gateway 108B will not be discussed further herein. However, it should be noted that the description of the first API gateway 108A applies similarly to the second API gateway 108B unless stated otherwise.

In the example of FIG. 1, the first compute cluster 104A and the second compute cluster 104B are implemented by Kubernetes® clusters. Additionally, in the example of FIG. 1, the first service 114A, the second service 114B, the third service 114C, and the fourth service 114D are implemented by Kubernetes® services. In additional or alternative examples, the first compute cluster 104A, the second compute cluster 104B, the first service 114A, the second service 114B, the third service 114C, and the fourth service 114D may be implemented with the resources and/or software of any other cloud service provider.

In the illustrated example of FIG. 1, the network layer 106 includes an example cloud service provider interface 116, a first example local traffic manager (LTM) 118A, a second example LTM 118B, a first example proxy 120A, a second example proxy 120B, a first example load balancer 122A, and a second example load balancer 122B. In the example of FIG. 1, the first LTM 118A, the first proxy 120A, and the first load balancer 122A are associated with the first compute cluster 104A. Additionally, in the example of FIG. 1, the second LTM 118B, the second proxy 120B, and the second load balancer 122B are associated with the second compute cluster 104B.

In the illustrated example of FIG. 1, the cloud service provider interface 116 is implemented by a user interface hosted by a cloud service provider hosting the virtual environment 100. For example, the cloud service provider includes at least one of Amazon Web Services® (AWS®), Akamai®, VMWare®, or Google Cloud™, among others. In the example of FIG. 1, the cloud service provider interface 116 implements identity and access management services to verify an identity and privileges of a user accessing the virtual environment 100 via the client device 102. Via the cloud service provider interface 116, the client device 102 can access one or more applications hosted by the first compute cluster 104A and/or the second compute cluster 104B.

In the illustrated example of FIG. 1, the first LTM 118A is implemented by a server executing software (e.g., Local Traffic Manager® provided by F5 Networks, Inc.). In the example of FIG. 1, the first LTM 118A distributes network traffic across one or more servers implementing the first proxy 120A. Additionally, the first LTM 118A adjusts the number of servers implementing the first proxy 120A as demand dictates. For example, the first LTM 118A provisions additional virtual resources on additional servers to implement the first proxy 120A when a large number (e.g., thousands to millions) of requests for the first compute cluster 104A are received. Additionally or alternatively, for example, the first LTM 118A deprovisions some of the virtual resources on the servers implementing the first proxy 120A when a smaller number of requests for the first compute cluster 104A are received.

In the illustrated example of FIG. 1, the first proxy 120A is implemented by one or more servers executing software (e.g., NGINX®). In the example of FIG. 1, the first proxy 120A serves as an intermediary between the client device 102 and the first compute cluster 104A. For example, the first proxy 120A receives a request from the client device 102 to access an application hosted by the first compute cluster 104A, evaluates the request to determine which application was requested, and performs one or more network transactions to forward the request to the requested application.

In the illustrated example of FIG. 1, the first load balancer 122A is implemented by a server executing software (e.g., NSX® Advanced Load Balancer provided by VMWare, Inc.). In the example of FIG. 1, the first load balancer 122A distributes network traffic across the two or more computers implementing the first compute cluster 104A. Additionally, the first load balancer 122A adjusts the number of computers implementing the first compute cluster 104A as demand dictates. For example, the first load balancer 122A provisions additional virtual resources on additional computers to implement the first compute cluster 104A when a large number (e.g., thousands to millions) of requests for the first compute cluster 104A are received. Additionally or alternatively, for example, the first load balancer 122A deprovisions some of the virtual resources on the computers implementing the first compute cluster 104A when a smaller number of requests for the first compute cluster 104A are received.

In the illustrated example of FIG. 1, the second LTM 118B, the second proxy 120B, and the second load balancer 1B are implemented similarly to the first LTM 118A, the first proxy 120A, and the first load balancer 122A, respectively. For purposes of conciseness, the second LTM 118B, the second proxy 120B, and the second load balancer 122B will not be discussed further herein. However, it should be noted that the description of the first LTM 118A, the first proxy 120A, and the first load balancer 122A applies similarly to the second LTM 118B, the second proxy 120B, and the second load balancer 122B, respectively, unless stated otherwise.

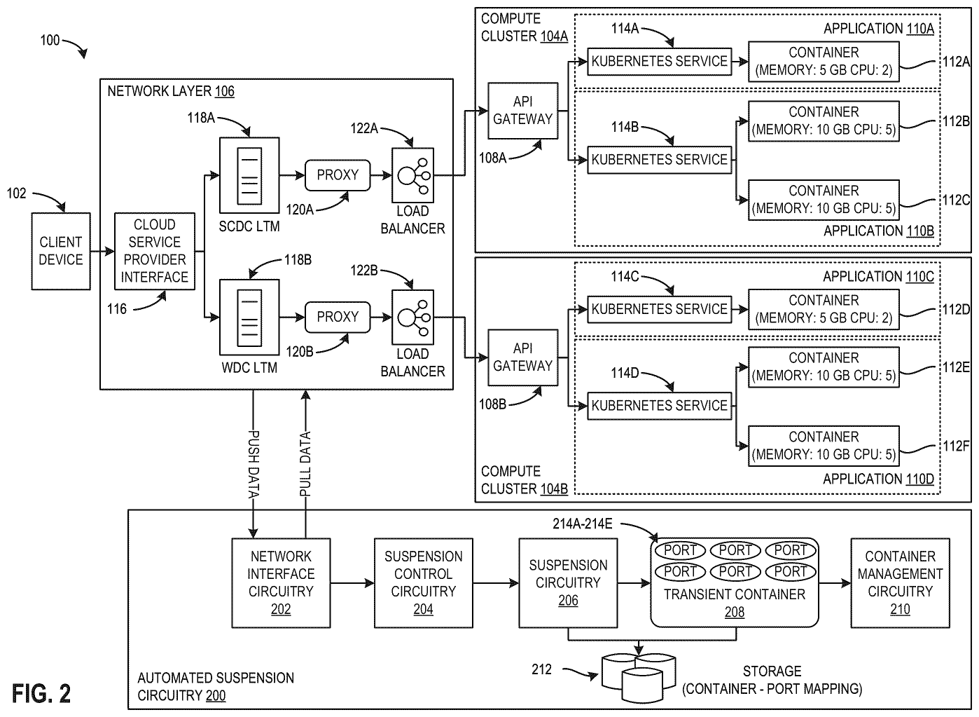

FIG. 2 is a block diagram illustrating example automated suspension circuitry 200 in relation to the virtual environment 100 of FIG. 1. In the example of FIG. 2, the automated suspension circuitry 200 includes example network interface circuitry 202, example suspension control circuitry 204, example suspension circuitry 206, an example transient container 208, example container management circuitry 210, and an example suspension management data store 212. In the example of FIG. 2, the transient container 208 includes example port 214A-214E.

In the illustrated example of FIG. 2, the automated suspension circuitry 200 of FIG. 2 may be instantiated (e.g., creating an instance of, bring into being for any length of time, materialize, implement, etc.) by processor circuitry such as a central processor unit executing instructions. Additionally or alternatively, the automated suspension circuitry 200 of FIG. 2 may be instantiated (e.g., creating an instance of, bring into being for any length of time, materialize, implement, etc.) by an ASIC or an FPGA structured to perform operations corresponding to the instructions (e.g., corresponding to instructions). It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

In the illustrated example of FIG. 2, the automated suspension circuitry 200 is implemented in the network layer 106. For example, the automated suspension circuitry 200 is implemented as part of the first load balancer 122A and/or the second load balancer 122B. In some examples, the automated suspension circuitry 200 is implemented as part of the first proxy 120A and/or the second proxy 120B.

In the illustrated example of FIG. 2, the network interface circuitry 202 is coupled to the network layer 106 and the suspension control circuitry 204. The example network interface circuitry 202 is implemented by a proxy server. In the example of FIG. 2, the network interface circuitry 202 monitors network traffic in the network layer 106 that is associated with a compute cluster (e.g., the first compute cluster 104A, the second compute cluster 104B, etc.) hosting a containerized application (e.g., the first application 110A, the second application 110B, the third application 110C, the fourth application 110D, etc.). For example, the network interface circuitry 202 monitors live network traffic (e.g., network traffic streaming through a proxy server) and/or network traffic logs. Example network traffic logs include historical network traffic.

In the illustrated example of FIG. 2, to monitor network traffic, the network interface circuitry 202 utilizes a push protocol and/or a pull protocol. For example, according to the push protocol, components of the network layer 106 redirect (e.g., forward) network traffic to the network interface circuitry 202 and/or duplicate network traffic and send the duplicated network traffic to the network interface circuitry 202. Additionally, for example, according to the pull protocol, the network interface circuitry 202 requests network traffic from components of the network layer 106. In some examples, the network interface circuitry 202 monitors server list instances to determine a level of demand for a containerized application.

In the illustrated example of FIG. 2, the network interface circuitry 202 processes network traffic to identify whether a device (e.g., the client device 102) has requested access to a containerized application. For example, the network interface circuitry 202 determines a number of requests to access a containerized application (e.g., a service) over a predefined period of time. Additionally or alternatively, the network interface circuitry 202 analyzes historical network traffic to determine a pattern of requests to access a containerized application.

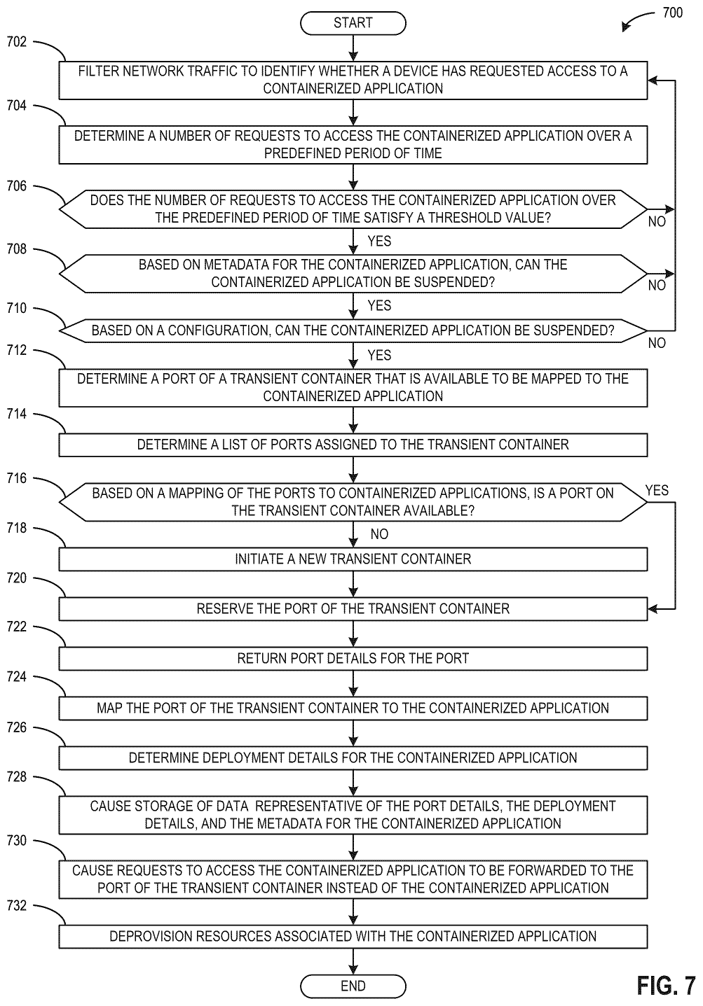

In some examples, the network interface circuitry 202 predicts a number of number of requests to access a containerized application (e.g., a service) over a predefined period of time without the predefined period of time having elapsed. In the example of FIG. 2, the predefined period of time may be configured by a developer of the automated suspension circuitry 200. The network interface circuitry 202 also forwards (e.g., transmits, causes transmission of, etc.) the number of requests to access the containerized application over the predefined period of time to the suspension control circuitry 204. Additionally, when a containerized application is suspended, the network interface circuitry 202 forwards network traffic (e.g., is to forward network traffic) associated with a compute cluster hosting the containerized application to a port of the transient container 208. In some examples, the network interface circuitry 202 is instantiated by processor circuitry executing network interface instructions and/or configured to perform operations such as those represented by the flowchart of FIG. 7.

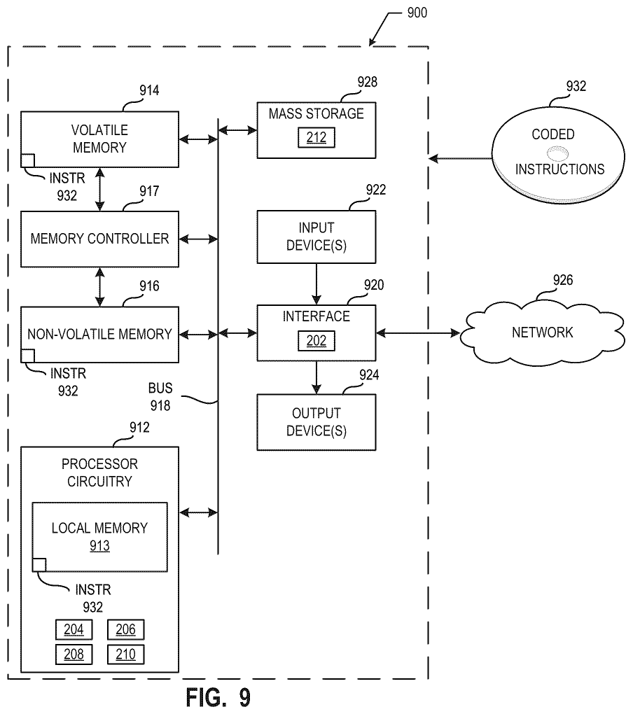

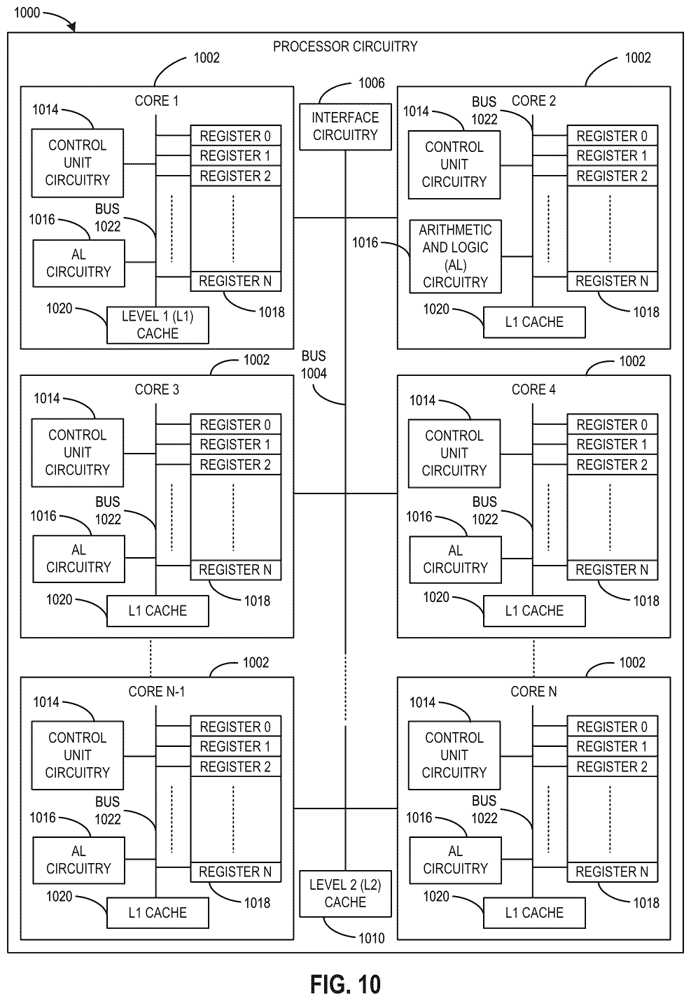

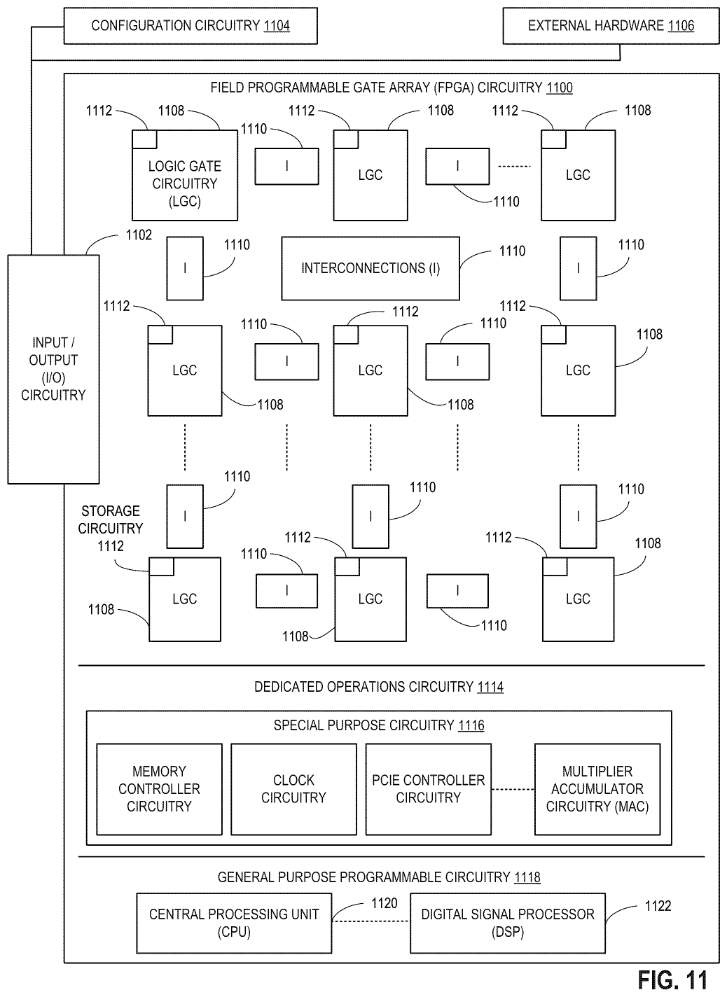

In some examples, the automated suspension circuitry 200 includes means for filtering. For example, the means for filtering may be implemented by the network interface circuitry 202. In some examples, the network interface circuitry 202 may be instantiated by processor circuitry such as the example processor circuitry 912 of FIG. 9. For instance, the network interface circuitry 202 may be instantiated by the example microprocessor 1000 of FIG. 10 executing machine executable instructions such as those implemented by at least blocks 702 and 704 of FIG. 7. In some examples, the network interface circuitry 202 may be instantiated by hardware logic circuitry, which may be implemented by an ASIC, XPU, or the FPGA circuitry 1100 of FIG. 11 structured to perform operations corresponding to the machine readable instructions. Additionally or alternatively, the network interface circuitry 202 may be instantiated by any other combination of hardware, software, and/or firmware. For example, the network interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In the illustrated example of FIG. 2, the suspension control circuitry 204 is coupled to the network interface circuitry 202 and the suspension circuitry 206. In the example of FIG. 2, the suspension control circuitry 204 determines whether to suspend a containerized application based on network traffic associated with a compute cluster hosting the containerized application. For example, the suspension control circuitry 204 implements a rule-based algorithm to determine whether to suspend a containerized application.

In the illustrated example of FIG. 2, the suspension control circuitry 204 accesses, from the network interface circuitry 202, a number of requests to access the containerized application over a predefined period of time. Additionally, the suspension control circuitry 204 determines whether the containerized application is active. In other words, the suspension control circuitry 204 determines whether there is a demand for the containerized application. determines whether the number of requests to access the containerized application over the predefined period of time satisfies a threshold value. For example, the threshold value is set to zero. In the example of FIG. 2, the threshold value may be configured by a developer of the automated suspension circuitry 200.

In the illustrated example of FIG. 2, in response to (e.g., based on) the number of requests to access the containerized application over the predefined period of time satisfying the threshold value, the suspension control circuitry 204 determines whether the containerized application can be suspended based on metadata for the containerized application. For example, metadata for a containerized application is stored in the suspension management data store 212 during onboarding of the containerized application to the production environment (e.g., the virtual environment 100). In this manner, the suspension control circuitry 204 identifies eligible resources in the virtual environment 100 that can be suspended.

In the illustrated example of FIG. 2, the suspension control circuitry 204 determines whether the metadata indicates that the containerized application is critical to operation of an enterprise (e.g., a business critical application such as a payment processing application in an e-commerce enterprise, an identity verification application in a banking enterprise, etc.). Additionally or alternatively, in the example of FIG. 2, the suspension control circuitry 204 determines whether the metadata indicates that the containerized application is related to revenue generation of an enterprise (e.g., a revenue related application such as a search algorithm application and/or product recommendation application in an e-commerce enterprise, an asset management application and/or a transaction processing application in a banking enterprise, etc.). In such examples, if the suspension control circuitry 204 determines that a containerized application is critical to operation of an enterprise and/or related to revenue generation of an enterprise, then the suspension control circuitry 204 determines that the containerized application cannot be suspended.

In the illustrated example of FIG. 2, in response to (e.g., based on) the metadata indicating that the containerized application can be suspended, the suspension control circuitry 204 determines whether the containerized application can be suspended based on a configuration associated with the containerized application. In the example of FIG. 2, the suspension control circuitry 204 determines one or more user-defined rules for whether to suspend the containerized application based on the configuration. For example, a developer of a containerized application may indicate in the application configuration, that the containerized application should not be suspended at the end of a fiscal quarter and/or at the end of a fiscal year. In examples disclosed herein, each containerized application may include different user-defined rules for whether to suspend the containerized application. Additionally, example configurations include an application configuration of a containerized application, a Kubernetes® namespace configuration for a Kubernetes® namespace of a compute cluster on which a containerized application is deployed, and a cluster-level configuration for a compute cluster on which a containerized application is deployed.

Additionally or alternatively, the suspension control circuitry 204 implements a machine learning model to determine whether a containerized application can be suspended. For example, the machine learning model processes application data and network data to determine whether a containerized application can be suspended. In some examples, before determining that a containerized application can be suspended, the suspension control circuitry 204 causes the network interface circuitry 202 to transmit an approval request to a user authorized to manage the containerized application. Additionally, in some examples, the suspension control circuitry 204 is instantiated by processor circuitry executing suspension control instructions and/or configured to perform operations such as those represented by the flowchart of FIG. 7.

In some examples, the automated suspension circuitry 200 includes means for determining. For example, the means for determining may be implemented by the suspension control circuitry 204. In some examples, the suspension control circuitry 204 may be instantiated by processor circuitry such as the example processor circuitry 912 of FIG. 9. For instance, the suspension control circuitry 204 may be instantiated by the example microprocessor 1000 of FIG. 10 executing machine executable instructions such as those implemented by at least blocks 706, 708, and 710 of FIG. 7. In some examples, the suspension control circuitry 204 may be instantiated by hardware logic circuitry, which may be implemented by an ASIC, XPU, or the FPGA circuitry 1100 of FIG. 11 structured to perform operations corresponding to the machine readable instructions. Additionally or alternatively, the suspension control circuitry 204 may be instantiated by any other combination of hardware, software, and/or firmware. For example, the suspension control circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In the illustrated example of FIG. 2, the suspension circuitry 206 is coupled to the suspension control circuitry 204 and the suspension management data store 212. In some examples, the suspension circuitry 206 also interfaces with the first compute cluster 104A and/or the second compute cluster 104B. In the example of FIG. 2, the suspension circuitry 206 determines a port of the transient container 208 that is available to be mapped to the containerized application. For example, the suspension circuitry 206 requests that the transient container 208 provide port details for an available port of the transient container 208.

In the illustrated example of FIG. 2, based on the port details of the available port, the suspension circuitry 206 maps the port of the transient container 208 to the containerized application. For example, the suspension circuitry 206 populates an entry of a lookup table (LUT) stored in the suspension management data store 212 to associate the port with the containerized application. Additionally, in the example of FIG. 2, the suspension circuitry 206 determines deployment details for the containerized application. For example, deployment details specify how to provision and/or deploy a containerized application and/or other virtualized resource.

In the illustrated example of FIG. 2, the suspension circuitry 206 determines metadata indicating how the containerized application is deployed and what resources are allocated to the containerized application, among other information. In some examples, the suspension circuitry 206 determines a blueprint for the containerized application. As used herein, a blueprint refers to a specification that defines a machine, application, and/or service that can be deployed to cloud resources. In additional or alternative examples, the suspension circuitry 206 determines a snapshot for a virtualized resource (e.g., a VM) that is to be suspended. As used herein, a snapshot refers to an image of the state and data of a virtualized resource (e.g., a VM) captured and stored at a point in time.

In the illustrated example of FIG. 2, the suspension circuitry 206 stores (e.g., causes storage of, is to cause storage of, etc.) data representative of the port details of the port to which a containerized application is mapped, the deployment details for the containerized application, and the metadata for the containerized application in the suspension management data store 212. For example, the suspension circuitry 206 causes the suspension management data store 212 to include the data representative of the port details, the deployment details, and the metadata with the entry of the LUT that associates the port with the containerized application. Additionally, in the example of FIG. 2, the suspension circuitry 206 causes requests to access the containerized application to be forwarded to the port of the transient container 208 instead of the containerized application. For example, the suspension circuitry 206 patches a Kubernetes® ingress and/or service to forward requests to the port of the transient container 208. In this manner, all new requests to the suspended containerized application are forwarded to the port of the transient container 208.

In the illustrated example of FIG. 2, the suspension circuitry 206 deprovisions resources associated with the containerized application. For example, the suspension circuitry 206 transmits (e.g., causes transmission of) one or more instructions to the containerized application to cause the resources allocated to the containerized application to be released to a collective pool of resources available to components of the virtual environment 100. For example, the suspension circuitry 206 transmits (e.g., causes transmission of) kubectl commands or Kubernetes® API calls to the containerized application. Additionally, in the example of FIG. 2, the suspension circuitry 206 determines whether any worker nodes and/or VMs on which the containerized application was deployed are no longer hosting any resources (e.g., are empty). If so, the suspension circuitry 206 deletes empty worker nodes and/or empty VMs. In some examples, the suspension circuitry 206 is instantiated by processor circuitry executing suspension instructions and/or configured to perform operations such as those represented by the flowchart of FIG. 7.

In some examples, the automated suspension circuitry 200 includes means for suspending. For example, the means for suspending may be implemented by the suspension circuitry 206. In some examples, the suspension circuitry 206 may be instantiated by processor circuitry such as the example processor circuitry 912 of FIG. 9. For instance, the suspension circuitry 206 may be instantiated by the example microprocessor 1000 of FIG. 10 executing machine executable instructions such as those implemented by at least blocks 712, 724, 726, 728, 730, and 732 of FIG. 7. In some examples, the suspension circuitry 206 may be instantiated by hardware logic circuitry, which may be implemented by an ASIC, XPU, or the FPGA circuitry 1100 of FIG. 11 structured to perform operations corresponding to the machine readable instructions. Additionally or alternatively, the suspension circuitry 206 may be instantiated by any other combination of hardware, software, and/or firmware. For example, the suspension circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In the illustrated example of FIG. 2, the transient container 208 is coupled to the container management circuitry 210 and the suspension management data store 212. In some examples, the transient container 208 also interfaces with the first compute cluster 104A and/or the second compute cluster 104B. In the example of FIG. 2, the transient container 208 monitors network traffic being forwarded to a port of the transient container 208 to detect whether a device has requested access to a suspended containerized application. In this manner, the transient container 208 determines whether there is demand for a suspended containerized application.

In the illustrated example of FIG. 2, in response to (e.g., based on) a threshold number of requests to access a suspended containerized application, the transient container 208 serves the request with static information without returning an error. In the example of FIG. 2, the threshold number of requests is one request. In examples disclosed herein, the threshold number of requests is configurable by a developer of the automated suspension circuitry 200. In the example of FIG. 2, the static information may include a message indicating to a user of a client device requesting access to the containerized application that the containerized application will be available momentarily. To serve the static information, the example transient container 208 transmits (e.g., causes transmission of) the message to the client device.

In some examples, the transient container 208 determines whether a predefined type of communication associated with a suspended containerized application has been received. In response to receiving the predefined type of communication, the transient container 208 serves the request with static information without returning an error. Additionally, in response to receiving a threshold number of requests to access a suspended containerized application and/or a predefined type of communication, the transient container 208 indicates to the container management circuitry 210 that the containerized application is to be redeployed.

In examples disclosed herein, the transient container 208 includes N (e.g., 6) ports and the N port are mapped to suspended containerized applications with a one-to-one ratio (e.g., one suspended containerized application mapped per port). For example, the transient container 208 includes a first example port 214A, a second example port 214B, a third example port 214C, a fourth example port 214D, a fifth example port 214E, and a sixth example port 214F. In examples disclosed herein, once all of the N ports of the transient container 208 are mapped to containerized applications, the transient container 208 provisions an additional transient container.

In some examples, the transient container 208 includes N (e.g., 6) ports and the N port are mapped to suspended containerized applications with a one-to-many ratio (e.g., one or more suspended containerized applications mapped per port). In such examples, the transient container 208 determines the domain of network traffic to identify which suspended containerized application is being requested from a port that includes multiple mappings. In the example of FIG. 2, the number (N) of ports allocated to the transient container 208 is based on the resources (e.g., compute resources, storage resources, memory resources, etc.) allocated to the transient container 208.

In the illustrated example of FIG. 2, after a containerized application is redeployed, the transient container 208 releases a port of the transient container 208 that was mapped to the containerized application (e.g., frees the port to be overwritten, discontinues monitoring of the port for network traffic associated with the containerized application, etc.). Additionally, the transient container 208 removes the mapping between the port and the containerized application from the suspension management data store 212. In some examples, the transient container 208 is instantiated by processor circuitry executing transient container instructions and/or configured to perform operations such as those represented by the flowcharts of FIGS. 7 and/or 8.

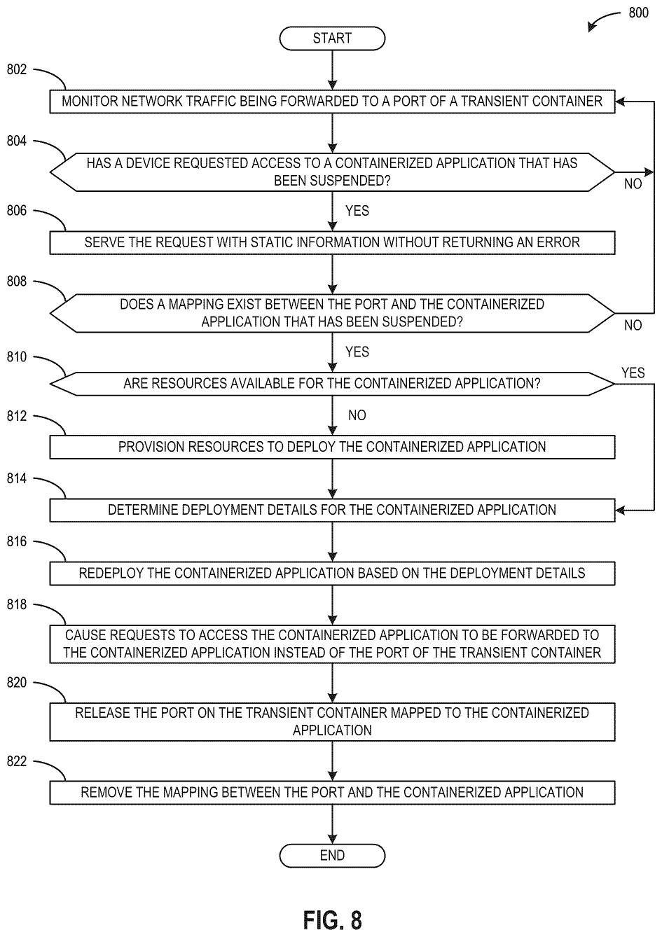

In some examples, the automated suspension circuitry 200 includes means for containing. For example, the means for containing may be implemented by the transient container 208. In some examples, the transient container 208 may be instantiated by processor circuitry such as the example processor circuitry 912 of FIG. 9. For instance, the transient container 208 may be instantiated by the example microprocessor 1000 of FIG. 10 executing machine executable instructions such as those implemented by at least blocks 714, 716, 718, 720, and 722 of FIG. 7 and/or at least blocks 802, 804, 806, 820, and 822 of FIG. 8. In some examples, the transient container 208 may be instantiated by hardware logic circuitry, which may be implemented by an ASIC, XPU, or the FPGA circuitry 1100 of FIG. 11 structured to perform operations corresponding to the machine readable instructions. Additionally or alternatively, the transient container 208 may be instantiated by any other combination of hardware, software, and/or firmware. For example, the transient container 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In the illustrated example of FIG. 2, the container management circuitry 210 is coupled to the transient container 208. In some examples, the container management circuitry 210 also interfaces with the first compute cluster 104A and/or the second compute cluster 104B. In the example of FIG. 2, the container management circuitry 210 redeploys containerized applications that have been suspended. For example, based on identification of a request to access a containerized application in network traffic associated with a compute cluster hosting the containerized application, the container management circuitry 210 redeploys the containerized application based on deployment details for the containerized application. In the example of FIG. 2, the container management circuitry 210 determines whether a mapping exists between a port of the transient container 208 and a containerized application that has been suspended. In the example of FIG. 2, the container management circuitry 210 accesses data stored in the suspension management data store 212 based on a mapping between the containerized application and a port of the transient container 208. For example, the transient container 208 forwards, to the container management circuitry 210, data representative of port details of a port to which a containerized application is mapped, deployment details for the containerized application, and metadata for the containerized application.

In the illustrated example of FIG. 2, in response to (e.g., based on) a mapping between a port of the transient container 208 and a containerized application existing, the container management circuitry 210 determines whether one or more resources are available for the containerized application. In the example of FIG. 2, in response to (e.g., based on) one or more resources being available for the containerized application, the container management circuitry 210 determines deployment details for the containerized application and redeploys the containerized application on the one or more resources. Alternatively, in response to (e.g., based on) one or more resources being unavailable for the containerized application, the container management circuitry 210 provisions one or more additional resources to deploy the containerized application. The container management circuitry 210 determines deployment details for the containerized application and redeploys the containerized application on the one or more additional resources.

In the illustrated example of FIG. 2, to redeploy a containerized application, the container management circuitry 210 utilizes Kubernetes® APIs to initiate a sequence of calls to the first compute cluster 104A and/or the second compute cluster 104B to redeploy the containerized application. In the example of FIG. 2, the sequence of calls is based on port details of a port to which the containerized application is mapped, deployment details for the containerized application, and/or metadata for the containerized application. In the example of FIG. 2, after a containerized application that was suspended is redeployed, the containerized application handles requests. In some examples, the container management circuitry 210 is instantiated by processor circuitry executing container management instructions and/or configured to perform operations such as those represented by the flowchart of FIG. 8.

In some examples, the automated suspension circuitry 200 includes means for redeploying. For example, the means for redeploying may be implemented by the container management circuitry 210. In some examples, the container management circuitry 210 may be instantiated by processor circuitry such as the example processor circuitry 912 of FIG. 9. For instance, the container management circuitry 210 may be instantiated by the example microprocessor 1000 of FIG. 10 executing machine executable instructions such as those implemented by at least blocks 808, 810, 812, 814, 816, and 818 of FIG. 8. In some examples, the container management circuitry 210 may be instantiated by hardware logic circuitry, which may be implemented by an ASIC, XPU, or the FPGA circuitry 1100 of FIG. 11 structured to perform operations corresponding to the machine readable instructions. Additionally or alternatively, the container management circuitry 210 may be instantiated by any other combination of hardware, software, and/or firmware. For example, the container management circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In the illustrated example of FIG. 2, the automated suspension circuitry 200 includes the suspension management data store 212 to record data (e.g., respective metadata for one or more containerized applications, one or more LUTs associating one or more ports of one or more transient containers with one or more containerized applications, port details of one or more ports to which one or more containerized applications are mapped, respective deployment details for one or more containerized applications, etc.). The suspension management data store 212 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The suspension management data store 212 may additionally or alternatively be implemented by one or more double data rate (DDR) memories, such as DDR, DDR2, DDR3, DDR4, DDR5, mobile DDR (mDDR), DDR SDRAM, etc. The suspension management data store 212 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the suspension management data store 212 is illustrated as three data stores, the suspension management data store 212 may be implemented by any number and/or type(s) of data stores, including a single data store. Furthermore, the data stored in the suspension management data store 212 may be in any data format such as, for example, binary data, comma delimited data, tab delimited data, structured query language (SQL) structures, etc.

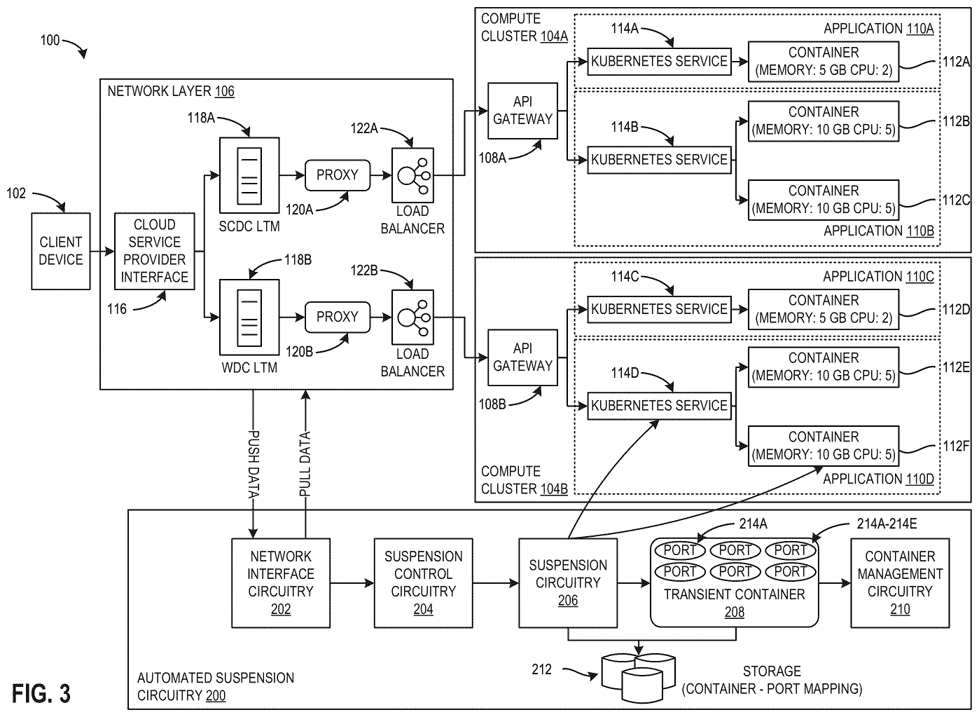

FIGS. 3-6 illustrate example operations of the automated suspension circuitry 200 of FIG. 2. For example, in the example of FIG. 3, the network interface circuitry 202 determines a number of requests to access the fourth application 110D over a predefined period of time. Additionally, in the example of FIG. 3, the suspension control circuitry 204 determines whether the number of requests to access the fourth application 110D satisfies a threshold value and, based on metadata for the fourth application 110D, whether the fourth application 110D can be suspended.

In the illustrated example of FIG. 3, in response to (e.g., based on) the suspension control circuitry 204 determining that the number of requests to access the fourth application 110D satisfies the threshold value and that the fourth application 110D can be suspended, the suspension circuitry 206 determines a port of the transient container 208 that is available to be mapped to the fourth application 110D. For example, the suspension circuitry 206 requests port details of an available port from the transient container 208. In the example of FIG. 3, the transient container 208 returns port details (e.g., is to return port details) for the first port 214A. Additionally, based on the port details of the first port 214A, the suspension circuitry 206 maps the first port 214A of the transient container 208 to the fourth application 110D.

In the illustrated example of FIG. 3, the suspension circuitry 206 determines deployment details for the fourth application 110D. Additionally, the suspension circuitry 206 stores (e.g., causes storage of, is to cause storage of, etc.) data representative of the port details of the first port 214A (e.g., the port to which the fourth application 110D is mapped), the deployment details for the fourth application 110D, and the metadata for the fourth application 110D in the suspension management data store 212. In the example of FIG. 3, the suspension circuitry 206 causes requests to access the fourth application 110D to be forwarded to the first port 214A of the transient container 208 instead of the fourth application 110D.

For example, the suspension circuitry 206 patches the fourth service 114D to forward requests to the port of the transient container 208. Additionally, in the example of FIG. 3, the suspension circuitry 206 deprovisions resources associated with the fourth application 110D. For example, the suspension circuitry 206 transmits (e.g., causes transmission of) one or more instructions (e.g., kubectl commands and/or Kubernetes® API calls) to the fifth container 112E and the sixth container 112F to cause resources allocated to the fifth container 112E and the sixth container 112F to be released. For example, based on the instructions from the suspension circuitry 206, the fifth container 112E is deprovisioned and ten gigabytes (GBs) of memory and five CPUs are released to the virtual environment 100. Additionally, based on the instructions from the suspension circuitry 206, the sixth container 112F is deprovisioned and ten GBs of memory and five CPUs are released to the virtual environment 100.

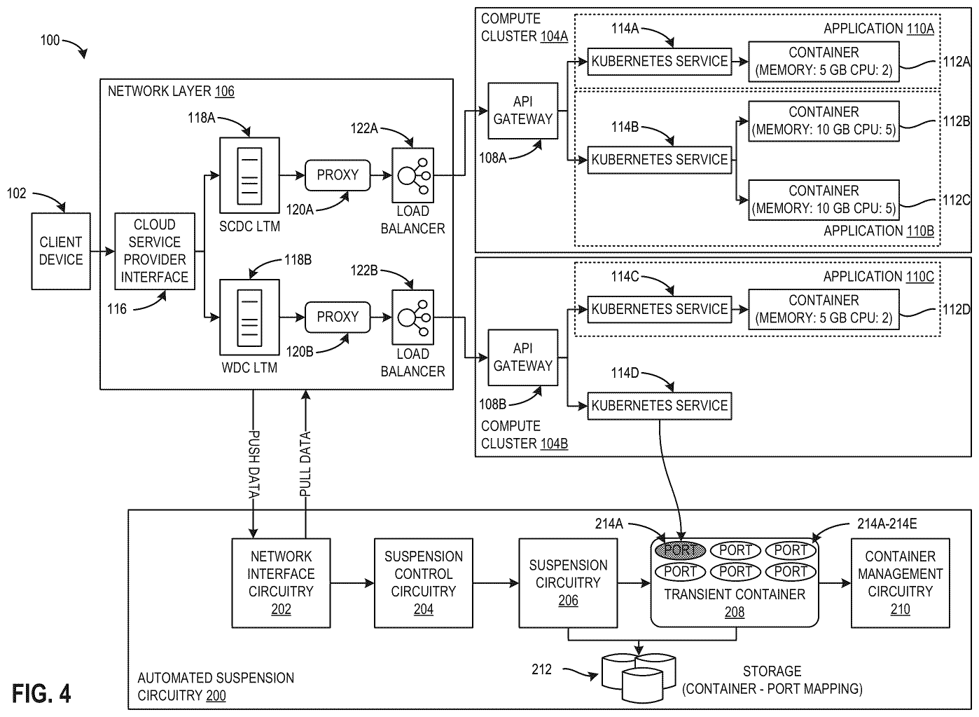

In the illustrated example of FIG. 4, the fourth application 110D is suspended. As such, all new requests to the fourth application 110D are forwarded to the first port 214A of the transient container 208. In this manner. In this manner, the transient container 208 can monitor network traffic being forwarded to the first port 214A to determine whether there is demand for the fourth application 110D. Thus, in operation, the transient container 208 is actively monitoring network traffic being forwarded to the first port 214A while the fourth application 110D is suspended.

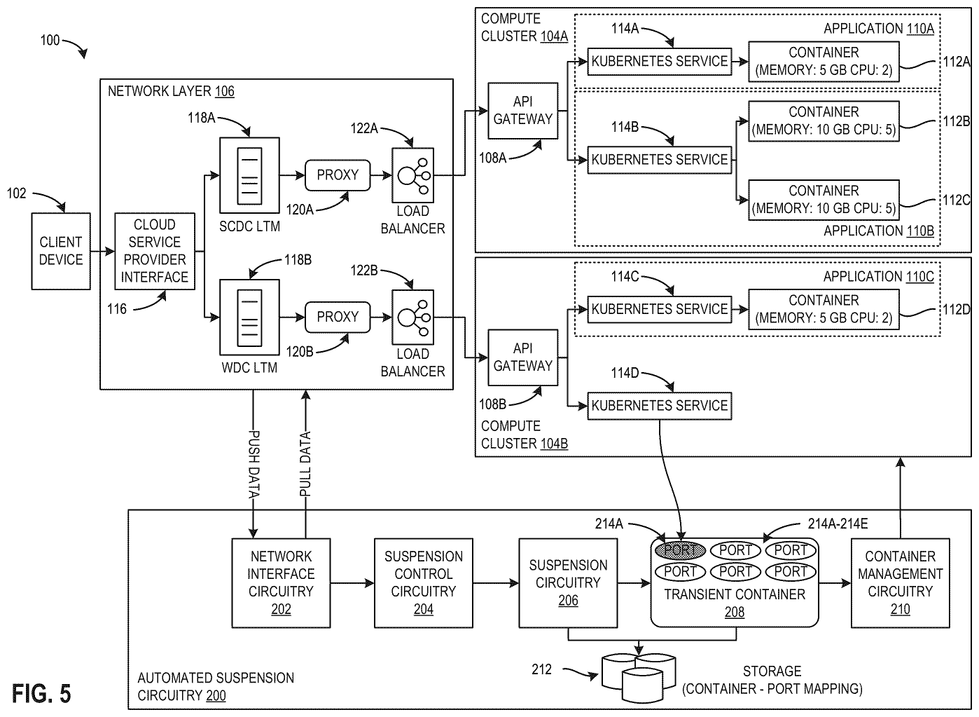

For example, in the illustrated example of FIG. 5, in response to (e.g., based on) a threshold number of requests (e.g., one request) to access the fourth application 110D, the transient container 208 indicates to the container management circuitry 210 that the fourth application 110D is to be redeployed. Additionally, the transient container 208 serves the request to access the fourth application 110D with static information without returning an error. For example, the example transient container 208 transmits (e.g., causes transmission of) a message indicating to a user of a client device requesting access to the fourth application 110D that the fourth application 110D will be available momentarily.

In the illustrated example of FIG. 5, the container management circuitry 210 determines whether a mapping exists between the first port 214A and the fourth application 110D. For example, the container management circuitry 210 requests port details of a port to which the fourth application 110D is mapped, deployment details for the fourth application 110D, and metadata for the fourth application 110D. If the port details of the port to which the fourth application 110D is mapped match the port details of the first port 214A (e.g., based on a comparison between the port details performed by the container management circuitry 210), then the container management circuitry 210 determines that a mapping exists between the first port 214A and the fourth application 110D.

In the illustrated example of FIG. 5, in response to (e.g., based on) a mapping between the first port 214A and the fourth application 110D existing, the container management circuitry 210 determines whether one or more resources are available for the fourth application 110D in the second compute cluster 104B. In the example of FIG. 2, in response to (e.g., based on) one or more resources being available for the fourth application 110D in the second compute cluster 104B, the container management circuitry 210 determines deployment details for the fourth application 110D and redeploys the fourth application 110D on the one or more resources. For example, to redeploy a containerized application, the container management circuitry 210 utilizes Kubernetes® APIs to initiate a sequence of calls (e.g., kubectl commands and/or Kubernetes® API calls) to the second compute cluster 104B to redeploy the fifth container 112E and the sixth container 112F.

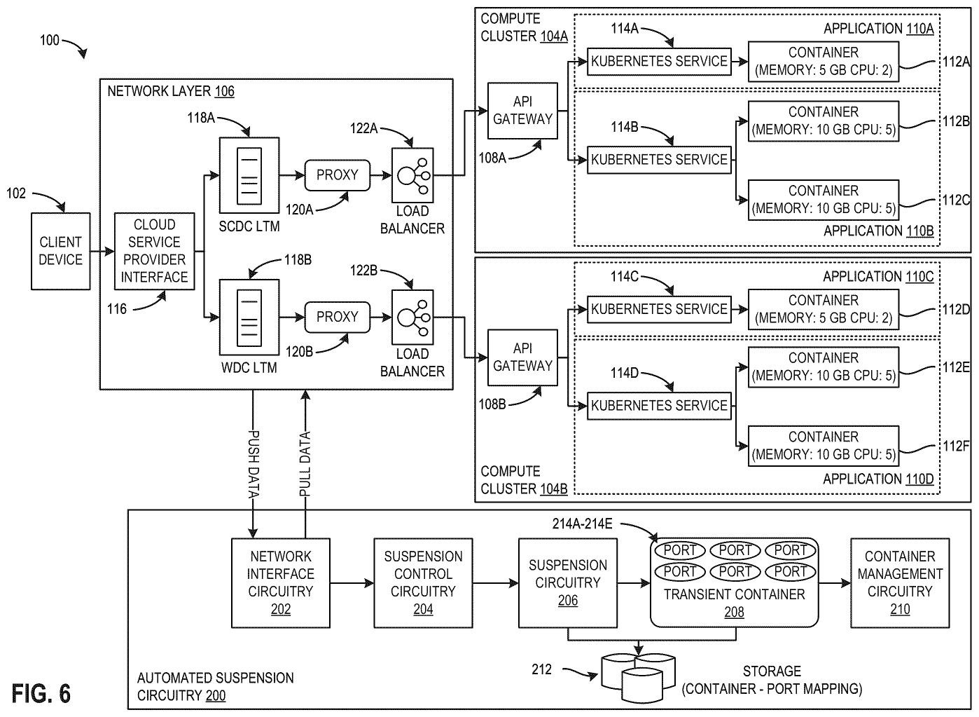

As illustrated in the example of FIG. 6, after the fourth application 110D is redeployed, the fourth application 110D serves the request that caused the container management circuitry 210 to redeploy the fourth application 110D. In examples disclosed herein, on a first request to access a containerized application that has been suspended, a client device will receive a response with some delay (e.g., 30-40 seconds), but the service associated with the containerized application will not return an error. Additionally, after the fourth application 110D is redeployed, the transient container 208 releases the first port 214A that was mapped to the fourth application 110D and removes the mapping between the first port 214A and the fourth application 110D from the suspension management data store 212.

While an example manner of implementing the automated suspension circuitry 200 of FIG. 2 is illustrated in FIG. 2, one or more of the elements, processes, and/or devices illustrated in FIG. 2 may be combined, divided, re-arranged, omitted, eliminated, and/or implemented in any other way. Further, the example network interface circuitry 202, the example suspension control circuitry 204, the example suspension circuitry 206, the example transient container 208, the example container management circuitry 210, the example suspension management data store 212, and/or, more generally, the example automated suspension circuitry 200 of FIG. 2, may be implemented by hardware alone or by hardware in combination with software and/or firmware. Thus, for example, any of the example network interface circuitry 202, the example suspension control circuitry 204, the example suspension circuitry 206, the example transient container 208, the example container management circuitry 210, the example suspension management data store 212, and/or, more generally, the example automated suspension circuitry 200 of FIG. 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example automated suspension circuitry 200 of FIG. 2 may include one or more elements, processes, and/or devices in addition to, or instead of, those illustrated in FIG. 2, and/or may include more than one of any or all of the illustrated elements, processes, and devices.

Flowcharts representative of example machine readable instructions, which may be executed to configure processor circuitry (e.g., to cause processor circuitry) to implement the automated suspension circuitry 200 of FIG. 2, are shown in FIGS. 7 and 8. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 7 and 8, many other methods of implementing the example automated suspension circuitry 200 of FIG. 2 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 7 and 8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed by example processor circuitry to implement the automated suspension circuitry 200 of FIG. 2 to suspend a containerized application. The machine readable instructions and/or the operations 700 of FIG. 7 begin at block 702, at which the network interface circuitry 202 filters network traffic (e.g., is to filter network traffic) to identify whether a device has requested access to the containerized application. For example, the network traffic is associated with a compute cluster hosting the containerized application.

In the illustrated example of FIG. 7, at block 704, the network interface circuitry 202 determines a number of requests to access the containerized application over a predefined period of time. For example, the predefined period of time is configurable by a developer of the automated suspension circuitry 200. At block 706, the suspension control circuitry 204 determines whether the number of requests to access the containerized application of the predefined period of time satisfies a threshold value. For example, the threshold value is zero. In additional or alternative examples, different threshold values may be used as desired by a developer of the automated suspension circuitry 200.

In the illustrated example of FIG. 7, in response to the suspension control circuitry 204 determining that the number of requests to access the containerized application of the predefined period of time satisfies the threshold value (block 706: YES), the machine readable instructions and/or the operations 700 proceed to block 708. In response to the suspension control circuitry 204 determining that the number of requests to access the containerized application of the predefined period of time does not satisfy the threshold value (block 706: NO), the machine readable instructions and/or the operations 700 return to block 702. At block 708, the suspension control circuitry 204 determines, based on metadata for the containerized application, whether the containerized application can be suspended.

For example, to determine whether the containerized application can be suspended, the suspension control circuitry 204 determines whether the metadata indicates that the containerized application is critical to operation of an enterprise and/or related to revenue generation of an enterprise. In the illustrated example of FIG. 7, in response to the suspension control circuitry 204 determining that the containerized application can be suspended (block 708: YES), the machine readable instructions and/or the operations 700 proceed to block 710. In response to the suspension control circuitry 204 determining that the containerized application cannot be suspended (block 708: NO), the machine readable instructions and/or the operations 700 return to block 702.

In the illustrated example of FIG. 7, at block 710, based on the metadata indicating that the containerized application can be suspended, the suspension control circuitry 204 determines whether the containerized application can be suspended based on a configuration associated with the containerized application. For example, the configuration may be an application configuration of the containerized application, a Kubernetes® namespace configuration for a Kubernetes® namespace of a compute cluster on which the containerized application is deployed, and a cluster-level configuration for the compute cluster on which the containerized application is deployed. In some examples, at block 710, the suspension control circuitry 204 executes a machine learning model to determine whether the containerized application can be suspended. In such examples, at block 710, the machine learning model processes application data and network data to determine whether the containerized application can be suspended. At block 712, the suspension circuitry 206 determines a port of the transient container 208 that is available to be mapped to the containerized application. For example, at block 712, the suspension circuitry 206 requests port details of an available port of the transient container 208.

In the illustrated example of FIG. 7, at block 714, the transient container 208 determines a list of ports assigned to the transient container 208. At block 716, based on a mapping of the ports of the transient container 208 to one or more containerized applications, the transient container 208 determines whether a port on the transient container 208 is available. In some examples, no containerized applications are mapped to the ports of the transient container 208 (e.g., when the transient container 208 is first initiated). In response to the transient container 208 determining that a port on the transient container 208 is available (block 716: YES), the machine readable instructions and/or the operations 700 proceed to block 720. In response to the transient container 208 determining that a port on the transient container 208 is not available (block 716: YES), the machine readable instructions and/or the operations 700 proceed to block 718.

In the illustrated example of FIG. 7, at block 718, based on a port of the transient container 208 being unavailable, the transient container 208 initiates (e.g., provisions, deploys, etc.) a second instance of the transient container 208. At block 720, based on a port of the transient container 208 being available (e.g., either on a first instance of the transient container 208 or a second instance of the transient container 208), the transient container 208 reserves the available port of the transient container 208. At block 722, the transient container 208 returns port details for the available port to the suspension circuitry 206. At block 724, the suspension circuitry 206 maps the available port of the transient container 208 to the containerized application.

In the illustrated example of FIG. 7, at block 726, the suspension circuitry 206 determines deployment details for the containerized application. For example, at block 726, the suspension circuitry 206 determines metadata indicating how the containerized application is deployed and what resources are allocated to the containerized application, among other information. In some examples, at block 726, the suspension circuitry 206 determines a blueprint for the containerized application. In additional or alternative examples, at block 726, the suspension circuitry 206 determines a snapshot for a virtualized resource (e.g., a VM) that is to be suspended. At block 728, the suspension circuitry 206 causes storage (e.g., is to cause storage of) of data representative of the port details of the port to which the containerized application is mapped, the deployment details for the containerized application, and the metadata for the containerized application.

In the illustrated example of FIG. 7, at block 730, the suspension circuitry 206 causes requests to access the containerized application to be forwarded to the port of the transient container 208 instead of the containerized application. For example, at block 730, the suspension circuitry 206 patches a Kubernetes® ingress and/or service implemented by the containerized application to forward requests to the port of the transient container 208. At block 732, the suspension circuitry 206 deprovisions one or more resources associated with the containerized application.

FIG. 8 is a flowchart representative of example machine readable instructions and/or example operations 800 that may be executed by example processor circuitry to implement the automated suspension circuitry of FIG. 2 to redeploy a containerized application. The machine readable instructions and/or the operations 800 of FIG. 8 begin at block 802, at which the transient container 208 monitors network traffic being forwarded to a port of the transient container 208. At block 804, the transient container 208 determines whether a device has requested access to a containerized application that has been suspended.

In the illustrated example of FIG. 8, in response to (e.g., based on) the transient container 208 determining that a device has requested access to the containerized application (block 804: YES), the machine readable instructions and/or the operations 800 proceed to block 806. In response to (e.g., based on) the transient container 208 determining that a device has not requested access to the containerized application (block 804: NO), the machine readable instructions and/or the operations 800 return to block 802. At block 806, based on the request to access the containerized application that has been suspended, the transient container 208 serves the request with static information without returning an error. For example, the transient container 208 serves the requesting device with a message indicating to a user of the requesting device that the containerized application will be available momentarily.

In the illustrated example of FIG. 8, at block 808, the container management circuitry 210 determines whether a mapping exists between the port of the transient container 208 and the containerized application that has been suspended. In response to (e.g., based on) the container management circuitry 210 determining that a mapping exists between the port of the transient container 208 and the containerized application (block: 808: YES), the machine readable instructions and/or the operations 800 proceed to block 810. In response to (e.g., based on) the container management circuitry 210 determining that a mapping does not exist between the port of the transient container 208 and the containerized application (block: 808: NO), the machine readable instructions and/or the operations 800 return to block 802.

In the illustrated example of FIG. 8, at block 810, the container management circuitry 210 determines whether one or more resources are available for the containerized application. In response to (e.g., based on) the container management circuitry 210 determining that there are one or more resources available for the containerized application (block 810: YES), the machine readable instructions and/or the operations 800 proceed to block 814. In response to (e.g., based on) the container management circuitry 210 determining that one or more resources are unavailable for the containerized application (block 810: NO), the machine readable instructions and/or the operations 800 proceed to block 812. At block 812, based on the one or more resources being unavailable for the containerized application, the container management circuitry 210 provisions one or more additional resources to deploy the containerized application.

In the illustrated example of FIG. 8, at block 814, based on one or more resources being available for the containerized application (e.g., either on one or more existing resources or one or more additional resource), the container management circuitry 210 determines deployment details for the containerized application. At block 816, the container management circuitry 210 redeploys the containerized application on the one or more resources based on deployment details for the containerized application. At block 818, the container management circuitry 210 causes requests to access the containerized application to be forwarded to the containerized application instead of the port of the transient container 208. At block 820, the transient container 208 releases the port of the transient container 208 that was mapped to the containerized application. At block 822, the transient container 208 removes the mapping between the port and the containerized application from the suspension management data store 212.

FIG. 9 is a block diagram of an example processor platform 900 structured to execute and/or instantiate the machine readable instructions and/or the operations 700 of FIG. 7 and/or the machine readable instructions and/or the operations 800 of FIG. 800 to implement the automated suspension circuitry 200 of FIG. 2. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs, microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements the example suspension control circuitry 204, the example suspension circuitry 206, the example transient container 208, and the example container management circuitry 210.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc. In this example, the interface circuitry 920 implements the example network interface circuitry 202.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 928 implements the example suspension management data store 212.

The machine readable instructions 932, which may be implemented by the machine readable instructions and/or the operations 700 of FIG. 7 and/or the machine readable instructions and/or the operations 800 of FIG. 800, may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowcharts of FIGS. 7 and/or 8 to effectively instantiate the circuitry of FIG. 2 as logic circuits to perform the operations corresponding to those machine readable instructions. In some such examples, the circuitry of FIG. 2 is instantiated by the hardware circuits of the microprocessor 1000 in combination with the instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 7 and/or 8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry 1016 (sometimes referred to as an ALU), a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control data movement (e.g., coordinate data movement) within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU) (also referred to as arithmetic and logic circuitry). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may be implemented by at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 7 and/or 8 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowcharts of FIGS. 7 and/or 8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowcharts of FIGS. 7 and/or 8. As such, the FPGA circuitry 1100 may be structured to effectively instantiate some or all of the machine readable instructions of the flowcharts of FIGS. 7 and/or 8 as dedicated logic circuits to perform the operations corresponding to those software instructions in a dedicated manner analogous to an ASIC. Therefore, the FPGA circuitry 1100 may perform the operations corresponding to the some or all of the machine readable instructions and/or operations of FIGS. 7 and/or 8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may be implemented by external hardware circuitry. For example, the external hardware 1106 may be implemented by the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations that may correspond to at least some of the machine readable instructions and/or operations of FIGS. 7 and/or 8 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor _00 of FIG. 5 and the example FPGA circuitry 1100 of FIG. 11. In some such hybrid examples, a first portion of the machine readable instructions represented by the flowcharts of FIGS. 7 and/or 8 may be executed by one or more of the cores 1002 of FIG. 10, a second portion of the machine readable instructions represented by the flowcharts of FIGS. 7 and/or 8 may be executed by the FPGA circuitry 1100 of FIG. 11, and/or a third portion of the machine readable instructions represented by the flowcharts of FIGS. 7 and/or 8 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

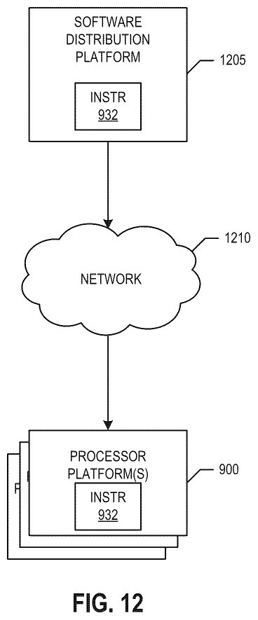

A block diagram illustrating an example software distribution platform 1205 to distribute software such as the example machine readable instructions 932 of FIG. 9 to hardware devices owned and/or operated by third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions and/or the example operations 700 of FIG. 7 and/or the example machine readable instructions and/or the example operations 800 of FIG. 800, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions 932 of FIG. 9, may be downloaded to the example processor platform 900, which is to execute the machine readable instructions 932 to implement the automated suspension circuitry 200. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices.

From the foregoing, it will be appreciated that example systems, methods, apparatus, and articles of manufacture have been disclosed that automate suspension and redeployment of cloud resources and automate redeployment of suspended cloud resources. For example, disclosed systems, method, apparatus, and articles of manufacture deprovision resources of containerized applications and/or other virtual resources (e.g., VMs) that are not demanded by users of a virtual environment. As such, examples disclosed herein allow for users to access virtual resources while reducing the computational burden of maintaining the virtual resources in a manner that allows users to access the virtual resources without receiving an error. Disclosed systems, methods, apparatus, and articles of manufacture improve the efficiency of using a computing device by suspending a containerized application (e.g., reducing the computational resources associated with the containerized application), monitoring requests for the containerized application, and in response to receipt of a request for the containerized application, restarting (e.g., reprovisioning and/or redeploying) the containerized application) without human intervention. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to automate suspension and redeployment of cloud resources are disclosed herein. Further examples and combinations thereof include the following:

Example 1 includes an apparatus to automate suspension of cloud resources, the apparatus comprising at least one memory, machine readable instructions, and processor circuitry to at least one of instantiate or execute the machine readable instructions to based on network traffic associated with a compute cluster hosting a containerized application, determine whether to suspend the containerized application, determine a port of a transient container that is available to be mapped to the containerized application, cause a request to access the containerized application to be forwarded to the port of the transient container instead of the containerized application, and deprovision one or more resources associated with the containerized application.

Example 2 includes the apparatus of example 1, wherein to determine whether to suspend the containerized application, the processor circuitry is to filter the network traffic to identify whether a device has requested access to the containerized application, based on a number of requests to access the containerized application over a predefined period of time satisfying a threshold value, determine whether the containerized application can be suspended based on metadata for the containerized application, and based on the metadata indicating that the containerized application can be suspended, determine whether the containerized application can be suspended based on a configuration associated with the containerized application.

Example 3 includes the apparatus of example 2, wherein the processor circuitry is to filter a log of the network traffic, the log including historical network traffic.

Example 4 includes the apparatus of example 2, wherein the processor circuitry is to filter the network traffic, the network traffic to stream through a proxy server associated with the compute cluster.

Example 5 includes the apparatus of example 1, wherein to determine the port of the transient container that is available to be mapped to the containerized application, the processor circuitry is to determine a list of one or more ports assigned to the transient container, determine whether the port of the transient container is available based on a mapping of the one or more ports to one or more containerized applications, and based on the port of the transient container being available, reserve the port of the transient container.

Example 6 includes the apparatus of example 5, wherein the port is a first port, the transient container is a first transient container, and the processor circuitry is to based on the first port on the first transient container being unavailable, initiate a second transient container, and reserve a second port of the second transient container.

Example 7 includes the apparatus of example 1, wherein the processor circuitry is to map the port of the transient container to the containerized application, determine deployment details for the containerized application, and cause storage of data representative of port details of the port, the deployment details for the containerized application, and metadata for the containerized application.

Example 8 includes a non-transitory machine readable storage medium comprising instructions that, when executed, cause processor circuitry to at least based on network traffic associated with a compute cluster hosting a containerized application, determine whether to suspend the containerized application, determine a port of a transient container that is available to be mapped to the containerized application, cause a request to access the containerized application to be forwarded to the port of the transient container instead of the containerized application, and deprovision one or more resources associated with the containerized application.

Example 9 includes the non-transitory machine readable storage medium of example 8, wherein to determine whether to suspend the containerized application, the instructions cause the processor circuitry to filter the network traffic to identify whether a device has requested access to the containerized application, based on a number of requests to access the containerized application over a predefined period of time satisfying a threshold value, determine whether the containerized application can be suspended based on metadata for the containerized application, and based on the metadata indicating that the containerized application can be suspended, determine whether the containerized application can be suspended based on a configuration associated with the containerized application.

Example 10 includes the non-transitory machine readable storage medium of example 9, wherein the instructions cause the processor circuitry to filter a log of the network traffic, the log including historical network traffic.

Example 11 includes the non-transitory machine readable storage medium of example 9, wherein the instructions cause the processor circuitry to filter the network traffic, the network traffic to stream through a proxy server associated with the compute cluster.

Example 12 includes the non-transitory machine readable storage medium of example 8, wherein to determine the port of the transient container that is available to be mapped to the containerized application, the instructions cause the processor circuitry to determine a list of one or more ports assigned to the transient container, determine whether the port of the transient container is available based on a mapping of the one or more ports to one or more containerized applications, and based on the port of the transient container being available, reserve the port of the transient container.

Example 13 includes the non-transitory machine readable storage medium of example 12, wherein the port is a first port, the transient container is a first transient container, and the instructions cause the processor circuitry to based on the first port on the first transient container being unavailable, initiate a second transient container, and reserve a second port of the second transient container.

Example 14 includes the non-transitory machine readable storage medium of example 8, wherein the instructions cause the processor circuitry to map the port of the transient container to the containerized application, determine deployment details for the containerized application, and cause storage of data representative of port details of the port, the deployment details for the containerized application, and metadata for the containerized application.

Example 15 includes a method to automate suspension of cloud resources, the method comprising based on network traffic associated with a compute cluster hosting a containerized application, determining, by executing an instruction with processor circuitry, whether to suspend the containerized application, determining, by executing an instruction with the processor circuitry, a port of a transient container that is available to be mapped to the containerized application, forwarding, by executing an instruction with the processor circuitry, a request to access the containerized application to the port of the transient container instead of the containerized application, and deprovisioning, by executing an instruction with the processor circuitry, one or more resources associated with the containerized application.

Example 16 includes the method of example 15, wherein determining whether to suspend the containerized application includes filtering the network traffic to identify whether a device has requested access to the containerized application, based on a number of requests to access the containerized application over a predefined period of time satisfying a threshold value, determining whether the containerized application can be suspended based on metadata for the containerized application, and based on the metadata indicating that the containerized application can be suspended, determining whether the containerized application can be suspended based on a configuration associated with the containerized application.

Example 17 includes the method of example 16, further including filtering a log of the network traffic, the log including historical network traffic.

Example 18 includes the method of example 16, further including filtering the network traffic, the network traffic streaming through a proxy server associated with the compute cluster.

Example 19 includes the method of example 15, wherein determining the port of the transient container that is available to be mapped to the containerized application includes determining a list of one or more ports assigned to the transient container, determining whether the port of the transient container is available based on a mapping of the one or more ports to one or more containerized applications, and based on the port of the transient container being available, reserving the port of the transient container.

Example 20 includes the method of example 18, wherein the port is a first port, the transient container is a first transient container, and the method further includes based on the first port on the first transient container being unavailable, initiating a second transient container, and reserving a second port of the second transient container.

Example 21 includes the method of example 15, further including mapping the port of the transient container to the containerized application, determining deployment details for the containerized application, and storing data representative of port details of the port, the deployment details for the containerized application, and metadata for the containerized application.

Example 22 includes an apparatus to automate suspension of cloud resources, the apparatus comprising interface circuitry to filter network traffic associated with a compute cluster hosting a containerized application to identify whether a device has requested access to the containerized application, and processor circuitry including one or more of at least one of a central processor unit (CPU), a graphics processor unit (GPU), or a digital signal processor (DSP), the at least one of the CPU, the GPU, or the DSP having control circuitry to control data movement within the processor circuitry, arithmetic and logic circuitry to perform one or more first operations corresponding to instructions, and one or more registers to store a first result of the one or more first operations, the instructions in the apparatus, a Field Programmable Gate Array (FPGA), the FPGA including first logic gate circuitry, a plurality of configurable interconnections, and storage circuitry, the first logic gate circuitry and the plurality of the configurable interconnections to perform one or more second operations, the storage circuitry to store a second result of the one or more second operations, or Application Specific Integrated Circuitry (ASIC) including second logic gate circuitry to perform one or more third operations, the processor circuitry to perform at least one of the first operations, the second operations, or the third operations to instantiate suspension control circuitry to, based on the network traffic, determine whether to suspend the containerized application, and suspension circuitry to determine a port of a transient container that is available to be mapped to the containerized application, cause a request to access the containerized application to be forwarded to the port of the transient container instead of the containerized application, and deprovision one or more resources associated with the containerized application.

Example 23 includes the apparatus of example 22, wherein to determine whether to suspend the containerized application, the processor circuitry is to perform at least one of the first operations, the second operations, or the third operations to instantiate the suspension control circuitry to based on a number of requests to access the containerized application over a predefined period of time satisfying a threshold value, determine whether the containerized application can be suspended based on metadata for the containerized application, and based on the metadata indicating that the containerized application can be suspended, determine whether the containerized application can be suspended based on a configuration associated with the containerized application.

Example 24 includes the apparatus of example 23, wherein the interface circuitry is to filter a log of the network traffic, the log including historical network traffic.

Example 25 includes the apparatus of example 23, wherein the interface circuitry is to filter the network traffic, the network traffic to stream through a proxy server associated with the compute cluster.

Example 26 includes the apparatus of example 22, wherein the processor circuitry is to perform at least one of the first operations, the second operations, or the third operations to instantiate the transient container to determine a list of one or more ports assigned to the transient container, determine whether the port of the transient container is available based on a mapping of the one or more ports to one or more containerized applications, based on the port of the transient container being available, reserve the port of the transient container, and return port details for the port to the suspension circuitry.

Example 27 includes the apparatus of example 26, wherein the port is a first port, the port details are first port details, the transient container is a first transient container, and the processor circuitry is to perform at least one of the first operations, the second operations, or the third operations to instantiate the first transient container to, based on the first port on the first transient container being unavailable, initiate a second transient container, and the second transient container to reserve a second port of the second transient container, and return second port details for the second port to the suspension circuitry.

Example 28 includes the apparatus of example 22, wherein the processor circuitry is to perform at least one of the first operations, the second operations, or the third operations to instantiate the suspension circuitry to map the port of the transient container to the containerized application, determine deployment details for the containerized application, and cause storage of data representative of port details of the port, the deployment details for the containerized application, and metadata for the containerized application.

Example 29 includes an apparatus to automate suspension of cloud resources, the apparatus comprising means for determining whether to suspend a containerized application based on network traffic associated with a compute cluster hosting the containerized application, and means for suspending the containerized application, the means for suspending the containerized application to determine a port of a transient container that is available to be mapped to the containerized application, cause a request to access the containerized application to be forwarded to the port of the transient container instead of the containerized application, and deprovision one or more resources associated with the containerized application.

Example 30 includes the apparatus of example 29, wherein the means for determining whether to suspend the containerized application is to based on a number of requests to access the containerized application over a predefined period of time satisfying a threshold value, determine whether the containerized application can be suspended based on metadata for the containerized application, and based on the metadata indicating that the containerized application can be suspended, determine whether the containerized application can be suspended based on a configuration associated with the containerized application.

Example 31 includes the apparatus of example 30, further including means for filtering the network traffic to identify whether a device has requested access to the containerized application, the network traffic included in a log including historical network traffic.

Example 32 includes the apparatus of example 30, further including means for filtering the network traffic to identify whether a device has requested access to the containerized application, the network traffic to stream through a proxy server associated with the compute cluster.

Example 33 includes the apparatus of example 29, further including the transient container, the transient container to determine a list of one or more ports assigned to the transient container, determine whether the port of the transient container is available based on a mapping of the one or more ports to one or more containerized applications, based on the port of the transient container being available, reserve the port of the transient container, and return port details for the port to the means for suspending the containerized application.

Example 34 includes the apparatus of example 33, wherein the port is a first port, the port details are first port details, the transient container is a first transient container, the first transient container is to, based on the first port on the first transient container being unavailable, initiate a second transient container, and the second transient container is to reserve a second port of the second transient container, and return second port details for the second port to the means for suspending the containerized application.

Example 35 includes the apparatus of example 29, wherein the means for suspending the containerized application is to map the port of the transient container to the containerized application, determine deployment details for the containerized application, and cause storage of data representative of port details of the port, the deployment details for the containerized application, and metadata for the containerized application.

Example 36 includes an apparatus to automate redeployment of suspended cloud resources, the apparatus comprising at least one memory, machine readable instructions, and processor circuitry to at least one of instantiate or execute the machine readable instructions to based on a first request to access a containerized application that has been suspended, redeploy the containerized application based on deployment details for the containerized application, and cause a second request to access the containerized application to be forwarded to the containerized application instead of a port of a transient container.

Example 37 includes the apparatus of example 36, wherein the processor circuitry is to monitor network traffic being forwarded to the port of the transient container, and determine whether a device has requested access to the containerized application.

Example 38 includes the apparatus of example 36, wherein the processor circuitry is to, based on the first request to access the containerized application that has been suspended, serve the first request with static information without returning an error.

Example 39 includes the apparatus of example 36, wherein the processor circuitry is to, based on a mapping between the port of the transient container and the containerized application existing, determine whether one or more resources are available for the containerized application.

Example 40 includes the apparatus of example 39, wherein the processor circuitry is to based on the one or more resources being available for the containerized application, determine deployment details for the containerized application, and redeploy the containerized application on the one or more resources.

Example 41 includes the apparatus of example 39, wherein the one or more resources are one or more first resources, and the processor circuitry is to based on the one or more first resources being unavailable for the containerized application, provision one or more second resources to deploy the containerized application, determine deployment details for the containerized application, and redeploy the containerized application on the one or more second resources.

Example 42 includes the apparatus of example 36, wherein the processor circuitry is to release the port of the transient container mapped to the containerized application, and remove the mapping between the port and the containerized application.

Example 43 includes a non-transitory machine readable storage medium comprising instructions that, when executed, cause processor circuitry to at least based on a first request to access a containerized application that has been suspended, redeploy the containerized application based on deployment details for the containerized application, and cause a second request to access the containerized application to be forwarded to the containerized application instead of a port of a transient container.

Example 44 includes the non-transitory machine readable storage medium of example 43, wherein the instructions cause the processor circuitry to monitor network traffic being forwarded to the port of the transient container, and determine whether a device has requested access to the containerized application.

Example 45 includes the non-transitory machine readable storage medium of example 43, wherein the instructions cause the processor circuitry to, based on the first request to access the containerized application that has been suspended, serve the first request with static information without returning an error.

Example 46 includes the non-transitory machine readable storage medium of example 43, wherein the instructions cause the processor circuitry to, based on a mapping between the port of the transient container and the containerized application existing, determine whether one or more resources are available for the containerized application.

Example 47 includes the non-transitory machine readable storage medium of example 46, wherein the instructions cause the processor circuitry to based on the one or more resources being available for the containerized application, determine deployment details for the containerized application, and redeploy the containerized application on the one or more resources.

Example 48 includes the non-transitory machine readable storage medium of example 46, wherein the one or more resources are one or more first resources, and the instructions cause the processor circuitry to based on the one or more first resources being unavailable for the containerized application, provision one or more second resources to deploy the containerized application, determine deployment details for the containerized application, and redeploy the containerized application on the one or more second resources.

Example 49 includes the non-transitory machine readable storage medium of example 43, wherein the instructions cause the processor circuitry to release the port of the transient container mapped to the containerized application, and remove the mapping between the port and the containerized application.

Example 50 includes a method to automate redeployment of suspended cloud resources, the method comprising based on a first request to access a containerized application that has been suspended, redeploying, by executing an instruction with processor circuitry, the containerized application based on deployment details for the containerized application, and forwarding, by executing an instruction with the processor circuitry, a second request to access the containerized application to the containerized application instead of a port of a transient container.

Example 51 includes the method of example 50, further including monitoring network traffic being forwarded to the port of the transient container, and determining whether a device has requested access to the containerized application.

Example 52 includes the method of example 50, further including, based on the first request to access the containerized application that has been suspended, serving the first request with static information without returning an error.

Example 53 includes the method of example 50, further including, based on a mapping between the port of the transient container and the containerized application existing, determining whether one or more resources are available for the containerized application.

Example 54 includes the method of example 53, further including based on the one or more resources being available for the containerized application, determining deployment details for the containerized application, and redeploying the containerized application on the one or more resources.

Example 55 includes the method of example 53, wherein the one or more resources are one or more first resources, and the method further includes based on the one or more first resources being unavailable for the containerized application, provisioning one or more second resources to deploy the containerized application, determining deployment details for the containerized application, and redeploying the containerized application on the one or more second resources.

Example 56 includes the method of example 50, further including releasing the port of the transient container mapped to the containerized application, and removing the mapping between the port and the containerized application.

Example 57 includes an apparatus to automate suspension of cloud resources, the apparatus comprising interface circuitry to forward network traffic associated with a compute cluster to a port of a transient container, and processor circuitry including one or more of at least one of a central processor unit (CPU), a graphics processor unit (GPU), or a digital signal processor (DSP), the at least one of the CPU, the GPU, or the DSP having control circuitry to control data movement within the processor circuitry, arithmetic and logic circuitry to perform one or more first operations corresponding to instructions, and one or more registers to store a first result of the one or more first operations, the instructions in the apparatus, a Field Programmable Gate Array (FPGA), the FPGA including first logic gate circuitry, a plurality of configurable interconnections, and storage circuitry, the first logic gate circuitry and the plurality of the configurable interconnections to perform one or more second operations, the storage circuitry to store a second result of the one or more second operations, or Application Specific Integrated Circuitry (ASIC) including second logic gate circuitry to perform one or more third operations, the processor circuitry to perform at least one of the first operations, the second operations, or the third operations to instantiate the transient container, and container management circuitry to based on identification of a first request to access a containerized application in the network traffic, redeploy the containerized application based on deployment details for the containerized application, the containerized application having been suspended, and cause a second request to access the containerized application to be forwarded to the containerized application instead of the port of the transient container.

Example 58 includes the apparatus of example 57, wherein the processor circuitry to perform at least one of the first operations, the second operations, or the third operations to instantiate the transient container to monitor the network traffic being forwarded to the port of the transient container, and determine whether a device has requested access to the containerized application.

Example 59 includes the apparatus of example 57, wherein the processor circuitry to perform at least one of the first operations, the second operations, or the third operations to instantiate the transient container to, based on the identification of the first request to access the containerized application, serve the first request with static information without returning an error.

Example 60 includes the apparatus of example 57, wherein the processor circuitry to perform at least one of the first operations, the second operations, or the third operations to instantiate the container management circuitry to, based on a mapping between the port of the transient container and the containerized application existing, determine whether one or more resources are available for the containerized application.

Example 61 includes the apparatus of example 60, wherein the processor circuitry to perform at least one of the first operations, the second operations, or the third operations to instantiate the container management circuitry to based on the one or more resources being available for the containerized application, determine deployment details for the containerized application, and redeploy the containerized application on the one or more resources.

Example 62 includes the apparatus of example 60, wherein the one or more resources are one or more first resources, and the processor circuitry to perform at least one of the first operations, the second operations, or the third operations to instantiate the container management circuitry to based on the one or more first resources being unavailable for the containerized application, provision one or more second resources to deploy the containerized application, determine deployment details for the containerized application, and redeploy the containerized application on the one or more second resources.

Example 63 includes the apparatus of example 57, the apparatus of example 60, wherein the processor circuitry to perform at least one of the first operations, the second operations, or the third operations to instantiate the transient container to release the port of the transient container mapped to the containerized application, and remove the mapping between the port and the containerized application.

Example 64 includes an apparatus to automate redeployment of suspended cloud resources, the apparatus comprising a transient container including one or more ports, and means for redeploying a containerized application based on a first request to access the containerized application, the containerized application having been suspended, the redeployment based on deployment details for the containerized application, the means for redeploying the containerized application to cause a second request to access the containerized application to be forwarded to the containerized application instead of a port of the transient container.

Example 65 includes the apparatus of example 64, wherein the transient container is to monitor network traffic being forwarded to the port of the transient container, and determine whether a device has requested access to the containerized application.

Example 66 includes the apparatus of example 64, wherein the transient container is to, based on identification of the first request to access the containerized application, serve the first request with static information without returning an error.

Example 67 includes the apparatus of example 64, wherein the means for redeploying the containerized application is to, based on a mapping between the port of the transient container and the containerized application existing, determine whether one or more resources are available for the containerized application.

Example 68 includes the apparatus of example 67, wherein the means for redeploying the containerized application is to based on the one or more resources being available for the containerized application, determine deployment details for the containerized application, and redeploy the containerized application on the one or more resources.

Example 69 includes the apparatus of example 67, wherein the one or more resources are one or more first resources, and the means for redeploying the containerized application is to based on the one or more first resources being unavailable for the containerized application, provision one or more second resources to deploy the containerized application, determine deployment details for the containerized application, and redeploy the containerized application on the one or more second resources.

Example 70 includes the apparatus of example 64, wherein the transient container is to release the port of the transient container mapped to the containerized application, and remove the mapping between the port and the containerized application.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to automate suspension of cloud resources, the apparatus comprising:
at least one memory;
machine readable instructions; and
processor circuitry to at least one of instantiate or execute the machine readable instructions to:
based on network traffic associated with a compute cluster hosting a containerized application, determine whether to suspend the containerized application;
determine a port of a transient container that is available to be mapped to the containerized application;
cause a request to access the containerized application to be forwarded to the port of the transient container instead of the containerized application; and
deprovision one or more resources associated with the containerized application.

2. The apparatus of claim 1, wherein to determine whether to suspend the containerized application, the processor circuitry is to:
filter the network traffic to identify whether a device has requested access to the containerized application;
based on a number of requests to access the containerized application over a predefined period of time satisfying a threshold value, determine whether the containerized application can be suspended based on metadata for the containerized application; and
based on the metadata indicating that the containerized application can be suspended, determine whether the containerized application can be suspended based on a configuration associated with the containerized application.

3. The apparatus of claim 2, wherein the processor circuitry is to filter a log of the network traffic, the log including historical network traffic.

4. The apparatus of claim 2, wherein the processor circuitry is to filter the network traffic, the network traffic to stream through a proxy server associated with the compute cluster.

5. The apparatus of claim 1, wherein to determine the port of the transient container that is available to be mapped to the containerized application, the processor circuitry is to:
determine a list of one or more ports assigned to the transient container;
determine whether the port of the transient container is available based on a mapping of the one or more ports to one or more containerized applications; and
based on the port of the transient container being available, reserve the port of the transient container.

6. The apparatus of claim 5, wherein the port is a first port, the transient container is a first transient container, and the processor circuitry is to:
based on the first port on the first transient container being unavailable, initiate a second transient container; and
reserve a second port of the second transient container.

7. The apparatus of claim 1, wherein the processor circuitry is to:
map the port of the transient container to the containerized application;
determine deployment details for the containerized application; and
cause storage of data representative of port details of the port, the deployment details for the containerized application, and metadata for the containerized application.

8. A non-transitory machine readable storage medium comprising instructions that, when executed, cause processor circuitry to at least:
based on network traffic associated with a compute cluster hosting a containerized application, determine whether to suspend the containerized application;
determine a port of a transient container that is available to be mapped to the containerized application;
cause a request to access the containerized application to be forwarded to the port of the transient container instead of the containerized application; and
deprovision one or more resources associated with the containerized application.

9. The non-transitory machine readable storage medium of claim 8, wherein to determine whether to suspend the containerized application, the instructions cause the processor circuitry to:
filter the network traffic to identify whether a device has requested access to the containerized application;
based on a number of requests to access the containerized application over a predefined period of time satisfying a threshold value, determine whether the containerized application can be suspended based on metadata for the containerized application; and
based on the metadata indicating that the containerized application can be suspended, determine whether the containerized application can be suspended based on a configuration associated with the containerized application.

10. The non-transitory machine readable storage medium of claim 9, wherein the instructions cause the processor circuitry to filter a log of the network traffic, the log including historical network traffic.

11. The non-transitory machine readable storage medium of claim 9, wherein the instructions cause the processor circuitry to filter the network traffic, the network traffic to stream through a proxy server associated with the compute cluster.

12. The non-transitory machine readable storage medium of claim 8, wherein to determine the port of the transient container that is available to be mapped to the containerized application, the instructions cause the processor circuitry to:
determine a list of one or more ports assigned to the transient container;
determine whether the port of the transient container is available based on a mapping of the one or more ports to one or more containerized applications; and
based on the port of the transient container being available, reserve the port of the transient container.

13. The non-transitory machine readable storage medium of claim 12, wherein the port is a first port, the transient container is a first transient container, and the instructions cause the processor circuitry to:
based on the first port on the first transient container being unavailable, initiate a second transient container; and
reserve a second port of the second transient container.

14. The non-transitory machine readable storage medium of claim 8, wherein the instructions cause the processor circuitry to:
map the port of the transient container to the containerized application;
determine deployment details for the containerized application; and
cause storage of data representative of port details of the port, the deployment details for the containerized application, and metadata for the containerized application.

15. A method to automate suspension of cloud resources, the method comprising:
based on network traffic associated with a compute cluster hosting a containerized application, determining, by executing an instruction with processor circuitry, whether to suspend the containerized application;
determining, by executing an instruction with the processor circuitry, a port of a transient container that is available to be mapped to the containerized application;
forwarding, by executing an instruction with the processor circuitry, a request to access the containerized application to the port of the transient container instead of the containerized application; and
deprovisioning, by executing an instruction with the processor circuitry, one or more resources associated with the containerized application.

16. The method of claim 15, wherein determining whether to suspend the containerized application includes:
filtering the network traffic to identify whether a device has requested access to the containerized application;
based on a number of requests to access the containerized application over a predefined period of time satisfying a threshold value, determining whether the containerized application can be suspended based on metadata for the containerized application; and
based on the metadata indicating that the containerized application can be suspended, determining whether the containerized application can be suspended based on a configuration associated with the containerized application.

17. The method of claim 16, further including filtering a log of the network traffic, the log including historical network traffic.

18. The method of claim 16, further including filtering the network traffic, the network traffic streaming through a proxy server associated with the compute cluster.

19. The method of claim 15, wherein determining the port of the transient container that is available to be mapped to the containerized application includes:
determining a list of one or more ports assigned to the transient container;
determining whether the port of the transient container is available based on a mapping of the one or more ports to one or more containerized applications; and
based on the port of the transient container being available, reserving the port of the transient container.

20. The method of claim 18, wherein the port is a first port, the transient container is a first transient container, and the method further includes:
based on the first port on the first transient container being unavailable, initiating a second transient container; and
reserving a second port of the second transient container.

21. The method of claim 15, further including:
mapping the port of the transient container to the containerized application;
determining deployment details for the containerized application; and
storing data representative of port details of the port, the deployment details for the containerized application, and metadata for the containerized application.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)
